(19) United States
(12) Patent Application Publication
(10) Pub. No.: US 2015/0163430 A1
(43) Pub. Date: Jun. 11, 2015

(54) SOLID STATE IMAGING DEVICE

(71) Applicant: Kabushiki Kaisha Toshiba, Minato-ku (JP)

(72) Inventors: Shiroshi KANEMITSU, Yokohama (JP); Atsuhiko NUNOKAWA, Yokohama (JP); Miho IIZUKA, Yokohama (JP); Jun INAGAWA, Yokohama (JP)

(73) Assignee: Kabushiki Kaisha Toshiba, Minato-ku (JP)

(21) Appl. No.: 14/473,247

(22) Filed: Aug. 29, 2014

(30) Foreign Application Priority Data
Dec. 9, 2013 (JP) 2013-254064

(51) Int. Cl. H04N 5/378; H04N 5/3745; H04N 5/355; H04N 5/369

(52) U.S. Cl. CPC H04N 5/378; H04N 5/3692; H04N 5/37455; H04N 5/355

(57) ABSTRACT

According to one embodiment, in the pixel array unit, pixels that accumulate photoelectrically converted electrical charge are arranged in a matrix state. The m address lines (m is an integer of two or more) are provided per row of the pixel array unit and select the pixel in a row direction. The vertical signal line transmits a pixel signal, which is read from the pixel, in a column direction.

### CROSS-REFERENCE TO RELATED APPLICATIONS

This application is based upon and claims the benefit of priority from Japanese Patent Application No. 2013-254064, filed on Dec. 9, 2013; the entire contents of which are incorporated herein by reference.

### FIELD

Embodiments described herein relate generally to a solid state imaging device.

### BACKGROUND

With regard to a CMOS image sensor, in order to speed up reading of a signal, there is a method of providing a plurality of vertical signal lines per column and reading the signal simultaneously from the plurality of lines. There is also a method in which gains are made different between lines, a line having a low gain is used for low sensitivity and a line having a high gain is used for high sensitivity, and in a case where the low sensitivity side is saturated, a dynamic range is expanded by interpolating the low sensitivity side with a high sensitivity pixel around a saturated pixel.

### BRIEF DESCRIPTION OF THE DRAWINGS

FIG. 1 is a block diagram illustrating a schematic configuration of a solid state imaging device according to a first embodiment;

FIG. 2 is a block diagram illustrating an example of a configuration of an address line of the solid state imaging device in FIG. 1;

FIG. 3 is a circuit diagram illustrating an example of a configuration of two pixels of the solid state imaging device in FIG. 1;

FIG. 4A is a timing chart illustrating an operation in normal reading of the solid state imaging device in FIG. 2;

FIG. 4B is a timing chart illustrating an operation in high speed reading of the solid state imaging device in FIG. 2;

FIG. 5 is a view illustrating read-out pixels in the high speed reading of the solid state imaging device in FIG. 2;

FIG. 6 is a block diagram illustrating an example of a configuration of an address line of a solid state imaging device according to a second embodiment;

FIG. 7 is a view illustrating read-out pixels in high speed reading of the solid state imaging device in FIG. 6;

FIG. 8 is a block diagram illustrating an example of a configuration of a vertical signal line of a solid state imaging device according to a third embodiment;

FIG. 9A is a block diagram illustrating a method of switching a switch in normal reading of the solid state imaging device in FIG. 8;

FIG. 9B is a block diagram illustrating a method of switching the switch in high speed reading of the solid state imaging device in FIG. 8;

FIG. 10 is a block diagram illustrating an example of a configuration of an address line and a vertical signal line of a solid state imaging device according to a fourth embodiment;

FIG. 11A is a timing chart illustrating an operation in normal reading of the solid state imaging device in FIG. 10;

FIG. 11B is a timing chart illustrating an operation in high speed reading of the solid state imaging device in FIG. 10;

FIG. 12 is a block diagram illustrating a schematic configuration of a solid state imaging device according to a fifth embodiment;

FIG. 13 is a block diagram illustrating an example of a configuration of an address line of the solid state imaging device in FIG. 12;

FIG. 14A is a view illustrating an output image when gains are made different between lines of the solid state imaging device in FIG. 12;

FIG. 14B is a view illustrating a synthetic image in which an output image of FIG. 14A is synthesized;

FIG. 15A is a view illustrating sensor output in which the gains are made different between the lines of the solid state imaging device in FIG. 12;

FIG. 15B is a view illustrating a method of synthesizing the sensor output of FIG. 15A; and

FIG. 16 is a block diagram illustrating a schematic configuration of a digital camera to which a solid state imaging device according to a sixth embodiment is applied.

### DETAILED DESCRIPTION

According to one embodiment, there are provided a pixel array unit, an address line, and a vertical signal line. In the pixel array unit, pixels that accumulate photoelectrically converted electrical charge are arranged in a matrix state. The m address lines (m is an integer of two or more) are provided per row of the pixel array unit and select the pixel in a row direction. The vertical signal line transmits a pixel signal, which is read from the pixel, in a column direction. Hereinafter, a solid state imaging device according to embodiments is described in detail with reference to the attached drawings. Note that the present invention is not to be limited by the embodiments.

(First Embodiment)

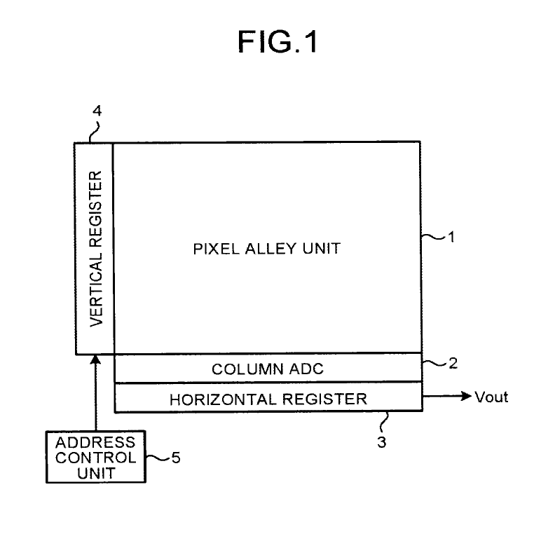

FIG. 1 is a block diagram illustrating a schematic configuration of a solid state imaging device according to a first embodiment.

In FIG. 1, the solid state imaging device is provided with a pixel array unit 1. In the pixel array unit 1, pixels PC that accumulate photoelectrically converted electrical charge are arranged in a matrix state in a row direction and in a column direction. Furthermore, the solid state imaging device is provided with: a column ADC circuit 2 configured to detect a signal component of each of the pixels PC per column by a CDS; a horizontal register 3 configured to forward the signal, which is detected by the column ADC circuit 2, in the row direction; a vertical register 4 configured to scan the pixels PC to be read in the column direction; and an address control unit 5 configured to select and control an address line, which selects the pixels PC to be read, in the row direction.

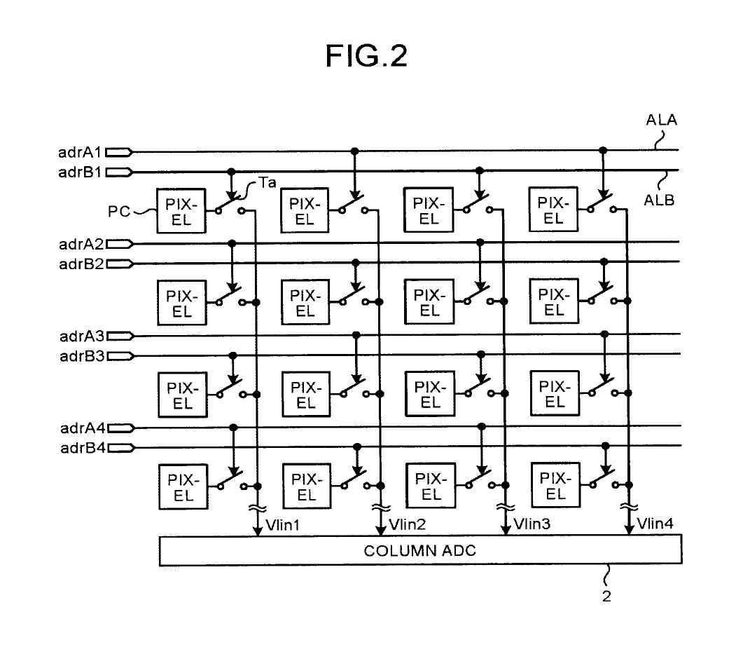

FIG. 2 is a block diagram illustrating an example of a configuration of the address line of the solid state imaging device in FIG. 1. Note that in FIG. 2, there is illustrated an example of the pixels PC arranged in a matrix state of 4×4 in the row direction and in the column direction.

In FIG. 2, the pixel array unit 1 is provided with two address lines ALA and ALB per row. Here, the address line ALA is capable of transmitting row selection signals adrA1 to adrA4 per row. The address line ALB is capable of transmitting row selection signals adrB1 to adrB4 per row. Furthermore, in the pixel array unit 1, vertical signal lines Vlin1 to Vlin4, which transmit a pixel signal read from the pixels PC in the column direction, are provided per column. Here, each of the pixels PC is provided with a row selection transistor Ta. Then, the address lines ALA and ALB are alternately connected to every other pixel PC in the row direction through the row selection transistor Ta.

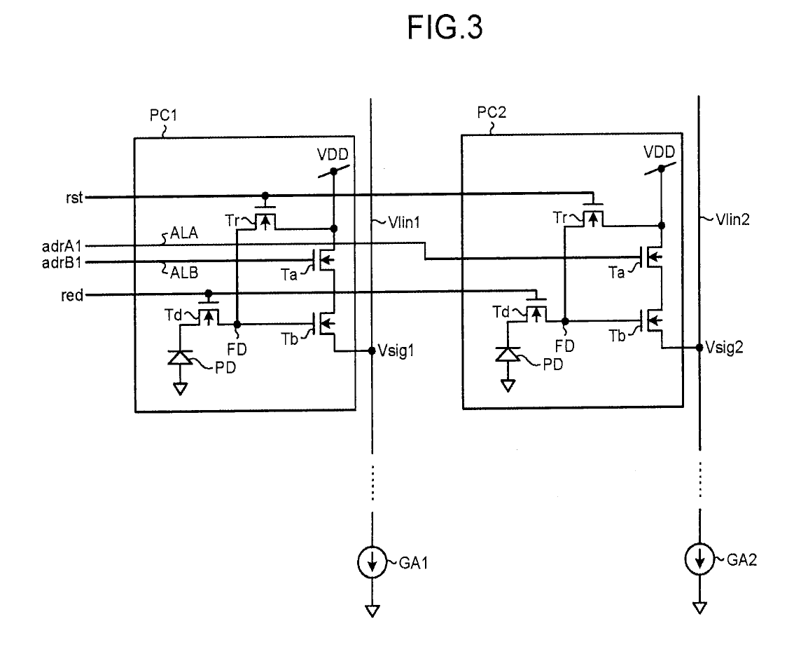

FIG. 3 is a circuit diagram illustrating an example of a configuration of two pixels of the solid state imaging device in FIG. 1. Note that in FIG. 3, two pixels PCI and PC2, adjacent to each other in the row direction, are used as an example.

In FIG. 3, each of the pixels PC1 and PC2 is provided with a photo diode PD, a row selection transistor Ta, an amplifier transistor Tb, a reset transistor Tr, and a read transistor Td. Furthermore, a floating diffusion FD is formed as a detection node at a connection point of the amplifier transistor Tb, the reset transistor Tr, and the read transistor Td.

Then, in each of the pixels PC1 and PC2, a source of the read transistor Td is connected to the photo diode PD, and a read signal red is input to a gate of the read transistor Td. A source of the reset transistor Tr is connected to a drain of the read transistor Td, a reset signal rst is input to a gate of the reset transistor Tr, and a drain of the reset transistor Tr is connected to a power supply potential VDD. A gate of the amplifier transistor Tb is connected to the drain of the read transistor Td, and a drain of the amplifier transistor Tb is connected to a source of the row selection transistor Ta. A drain of the row selection transistor Ta is connected to the power supply potential VDD. Furthermore, vertical signal lines Vlin1 and Vlin2 are connected to constant current sources GA1 and GA2, respectively, and pixel signals Vsig1 and Vsig2 are output from each of the pixels PC1 and PC2 to the vertical signal lines Vlin1 and Vlin2.

Furthermore, in the pixel PC1, a source of the amplifier transistor Tb is connected to the vertical signal line Vlin1, and a row selection signal adrA1 is input to a gate of the row selection transistor Ta through the address line ALE. In the pixel PC2, a source of the amplifier transistor Tb is connected to the vertical signal line Vlin2, and the row selection signal adrA1 is input to a gate of the row selection transistor Ta through the address line ALA.

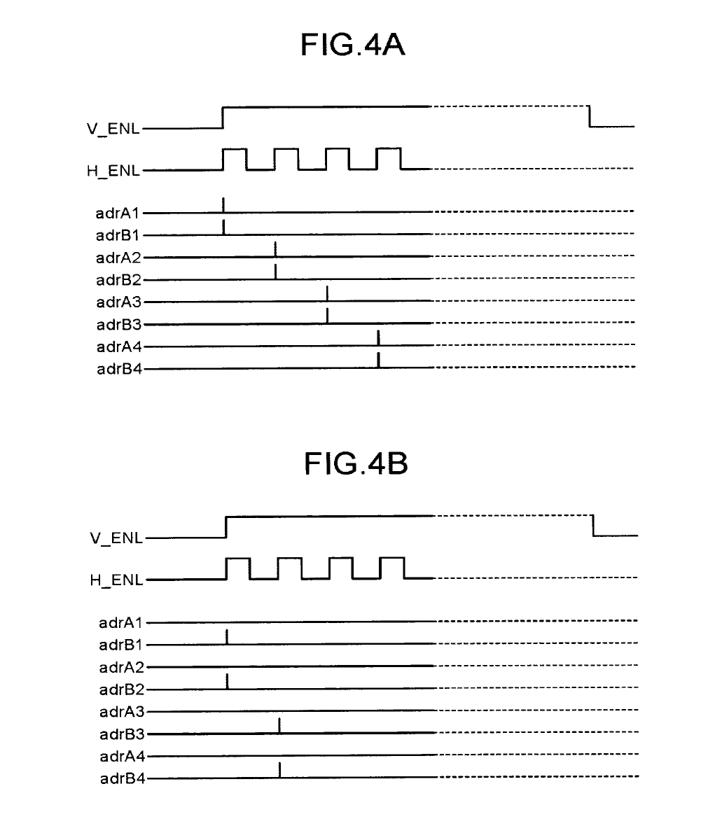

FIG. 4A is a timing chart illustrating operation in normal reading of the solid state imaging device in FIG. 2, and FIG. 4B is a timing chart illustrating operation in high speed reading of the solid state imaging device in FIG. 2.

In FIG. 4A, in the normal reading, two address lines ALA and ALB are simultaneously selected per row through the address control unit 5. Then, the pixel signal read from the pixel PC is transmitted per column to the column ADC circuit 2 through the vertical signal lines Vlin1 to Vlin4.

That is, in a case where the row selection signals adrA1 to adrA4 and adrB1 to adrB4 are at a low level, the row selection transistor Ta enters an off state, and no signal is output to the vertical signal lines Vlin1 to Vlin4. At this time, when the read signal red and the reset signal rst become a high level, the read transistor Td is turned on, and the electrical charge accumulated in the photo diode PD is discharged to the floating diffusion FD. Then, it is discharged to the power supply potential VDD through the reset transistor Tr. After the electrical charge accumulated in the photo diode PD is discharged to the power supply potential VDD, when the read signal red becomes the low level, accumulation of an effective signal charge is started in the photo diode PD.

Next, when the reset signal rst rises, the reset transistor Tr is turned on, and an excessive electrical charge generated by a leak current and the like is discharged to the floating diffusion FD.

Then, after a vertical synchronization signal V_ENL rises, when the row selection signals adrA1 and adrB1 become a high level in synchronization with a horizontal synchronization signal H_ENL, the row selection transistor Ta is turned on in the pixel PC in a first row. Then, by the power supply potential VDD being applied to the drain of the amplifier transistor Tb, the amplifier transistor Tb performs a source follower operation, and voltage in accordance with a reset level of the floating diffusion FD is applied to the gate of the amplifier transistor Tb. At this time, voltage of the vertical signal lines Vlin1 to Vlin4 follows the voltage applied to the gate of the amplifier transistor Tb, and a pixel signal at the reset level is output to the column ADC circuit 2 through each of the vertical signal lines Vlin1 to Vlin4.

Then, in the column ADC circuit 2, the pixel signal at the reset level is down counted until it equals a standard voltage level, whereby the pixel signal at the reset level is converted into and held as a digital value.

Next, when the read signal red rises, the read transistor Td is turned on in the pixel PC in the first row, the electrical charge accumulated in the photo diode PD is forwarded to the floating diffusion FD, and voltage in accordance with a signal level of the floating diffusion FD is applied to the gate of the amplifier transistor Tb. At this time, the voltage of the vertical signal lines Vlin1 to Vlin4 follows the voltage applied to the gate of the amplifier transistor Tb, and a pixel signal at the signal level is output to the column ADC circuit 2 through each of the vertical signal lines Vlin1 to Vlin4.

Then, in the column ADC circuit 2, the pixel signal at the signal level is up counted until it equals the standard voltage level, whereby the pixel signal at the signal level is converted into a digital value. Then, a difference between the pixel signal at the reset level and the pixel signal at the signal level is held per column and is output as an output signal Vout through the horizontal register 3.

Hereinafter, in the same way, the signal is read from the pixels PC in second to fourth rows in order by the row selection signals adrA2 to adrA4 and adrB2 to adrB4 becoming the high level in order in synchronization with the horizontal synchronization signal H_ENL.

In FIG. 4B, in the high speed reading, one address line ALB is selected per two rows, simultaneously. Then, the pixel signal read from the pixel PC is transmitted to the column ADC circuit 2 per column through the vertical signal lines Vlin1 to Vlin4.

That is, after the vertical synchronization signal V_ENL rises, when the row selection signals adrB1 and adrB2 simultaneously become the high level in synchronization with the horizontal synchronization signal H_ENL, every other row selection transistor Ta in the row direction is turned on among the pixels PC in first and second rows. At this time, such that the column is alternately selected between the pixels PC in the first row and the pixels PC in the second row, the pixel PC to be turned on by the row selection transistor Ta may be shifted by one pixel. Then, by the power supply potential VDD being applied to the drain of the amplifier transistor Tb, the amplifier transistor Tb performs the source follower operation, and the voltage in accordance with the reset level of the floating diffusion FD is applied to the gate of the amplifier transistor Tb. At this time, the voltage of the vertical signal lines Vlin1 to Vlin4 follows the voltage applied to the gate of the amplifier transistor Tb, and the pixel signal at the reset level is output to the column ADC circuit 2 through each of the vertical signal lines Vlin1 to Vlin4.

Then, in the column ADC circuit 2, the pixel signal at the reset level is down counted until it equals the standard voltage level, whereby the pixel signal at the reset level is converted into and held as the digital value.

Next, when the read signal red rises, the read transistor Td is turned on in the pixels PC in the first and second rows, the electrical charge accumulated in the photo diode PD is forwarded to the floating diffusion FD, and the voltage in accordance with the signal level of the floating diffusion FD is applied to the gate of the amplifier transistor Tb. Then, the power supply potential VDD is applied to every other drain of the amplifier transistor Tb in the row direction through the row selection transistor Ta, whereby the amplifier transistor Tb performs the source follower operation. At this time, the voltage of the vertical signal lines Vlin1 to Vlin4 follows the voltage applied to the gate of the amplifier transistor Tb, and the pixel signal at the signal level is output to the column ADC circuit 2 through each of the vertical signal lines Vlin1 to Vlin4.

Then, in the column ADC circuit 2, the pixel signal at the signal level is up counted until it equals the standard voltage level, whereby the pixel signal at the signal level is converted into the digital value. Then, a difference between the pixel signal at the reset level and the pixel signal at the signal level is held for each column and is output as the output signal Vout through the horizontal register 3.

Hereinafter, in the same way, the signal is read from every other pixel PC in third and fourth rows in the row direction by the row selection signals adrB3 and adrB4 becoming a high level simultaneously in synchronization with the horizontal synchronization signal H_ENL.

Here, in the normal reading in FIG. 4A, it takes two periods of time of the horizontal synchronization signal H_ENL to read signals for two rows. On the other hand, in the high speed reading in FIG. 4B, it takes one period of time of the horizontal synchronization signal H_ENL to read the signals for two rows, whereby it is possible to reduce read time by half. Furthermore, in a case where the high speed reading in FIG. 4B is realized, the column ADC circuit 2 may be provided for one line, and it is not necessary to provide the column ADC circuit 2 for two lines, whereby it is possible to suppress an increase of a circuit scale.

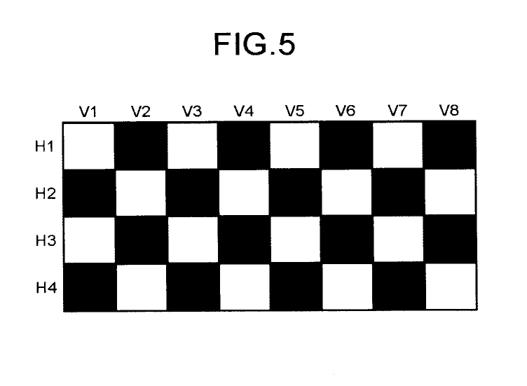

FIG. 5 is a view illustrating read-out pixels in the high speed reading of the solid state imaging device in FIG. 2. Note that in FIG. 5, there is illustrated an example of the pixels PC arranged in a matrix state of 4×8 in the row direction and in the column direction. Here, H1 to H4 denote the first to fourth rows, respectively, and V1 to V8 denote first to eighth columns, respectively. Furthermore, black portions in FIG. 5 denote thinned pixels in the high speed reading in FIG. 4B.

In FIG. 5, in the high speed reading in FIG. 4B, the pixels are thinned so as to correspond to a checkered pattern. In this method of thinning, it is possible to make an angle of view the same as that in the normal reading in FIG. 4A. Furthermore, it is possible to compensate for a decrease in resolution by interpolating a thinned pixel using pixels adjacent to the left, right, top, and bottom.

Note that in the above-described embodiment, a method has been described in which two address lines are provided per row of the pixel array unit 1, the address lines are connected to every other pixel PC in the row direction, and one address line is selected for one row in the normal reading operation while one address line is simultaneously selected for two rows, one by one, in the high speed reading operation. Note, however, that it is also possible to provide m (m is an integer of two or more) address lines per row of the pixel array unit 1, to connect the address line to every (m−1)×n (n is a positive integer) pixel PC in the row direction, and to select m address lines per row in the normal reading operation while selecting one address line per m rows, one by one, simultaneously in the high speed reading operation.

(Second Embodiment)

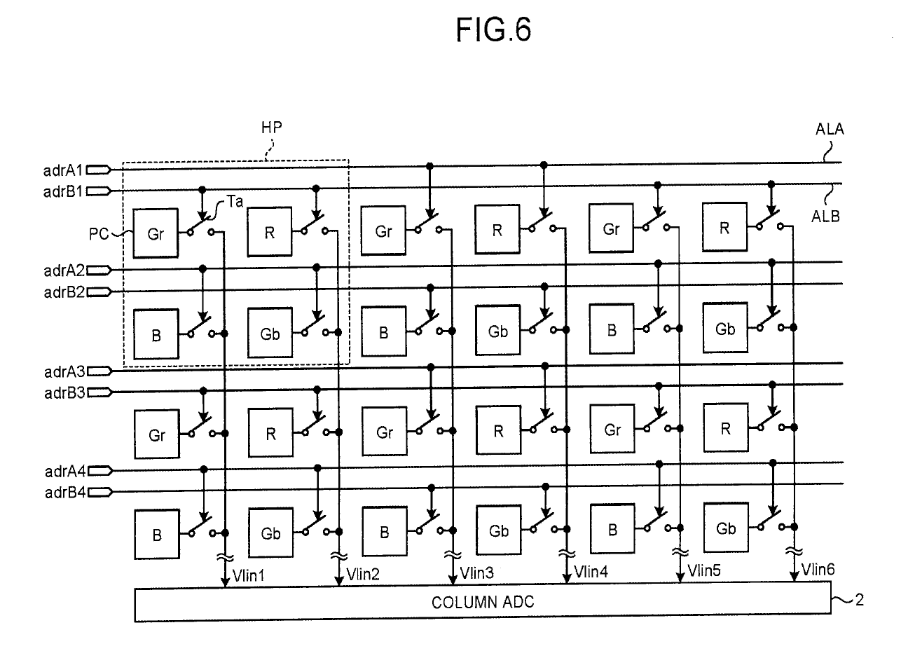

FIG. 6 is a block diagram illustrating an example of a configuration of an address line of a solid state imaging device according to a second embodiment.

In FIG. 6, the solid state imaging device has a Bayer array HP applied to the configuration in FIG. 2. The Bayer array HP can be constituted to have four pixels PC as one set. In this Bayer array HP, four pixels PC constitute one set, in which two color pixels for green Gr and Gb are arranged in one diagonal direction and one color pixel for red R and one color pixel for blue B are arranged in the other diagonal direction.

Then, when this Bayer array HP is applied, it is configured such that four pixels PC constituting the Bayer array HP are simultaneously read even in a case where the pixel PC is thinned in high speed reading.

That is, in a pixel array unit 1, two address lines ALA and ALB are provided per row. Then, each of the address lines ALA and ALB is alternately connected to every two pixels PC in a row direction through row selection transistors Ta.

Note that timing charts in normal reading and in the high speed reading are the same as those in FIGS. 4A and 4B. At this time, in the high speed reading, the address lines ALA and ALB are alternately connected to every two pixels PC in the row direction, whereby it is possible to simultaneously read four pixels PC constituting the Bayer array HP.

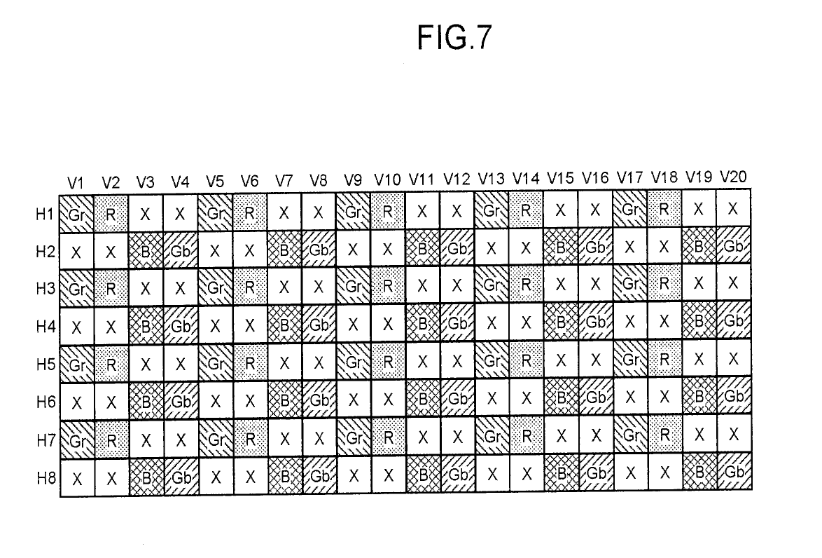

FIG. 7 is a view illustrating the read-out pixels in the high speed reading of the solid state imaging device in FIG. 6. Note that in FIG. 7, there is illustrated an example of the pixels PC arranged in a matrix state of 8×20 in the row direction and in a column direction. Here, H1 to H8 denote first to eighth rows, respectively, and V1 to V20 denote first to twentieth columns, respectively. Furthermore, portions with an x-mark in FIG. 7 denote pixels thinned in the high speed reading.

In FIG. 7, pixels PC of columns V1, V2, V5, V6, V9, V10, V13, V14, V17, and V18 in a first row H1 and pixels PC of columns V3, V4, V7, V8, V11, V12, V15, V16, V19, and V20 in a second row P2 are simultaneously read.

Furthermore, the color pixel for green Gr and the color pixel for red R, which are thinned in the first row H1, can be respectively interpolated with the color pixel for green Gr and the color pixel for red R adjacent to the right and left in the first row H1. The color pixel for green Gb and the color pixel for blue B, which are thinned in the second row H2, can be respectively interpolated with the color pixel for green Gb and the color pixel for blue B adjacent to the right and left in the second row H2.

(Third Embodiment)

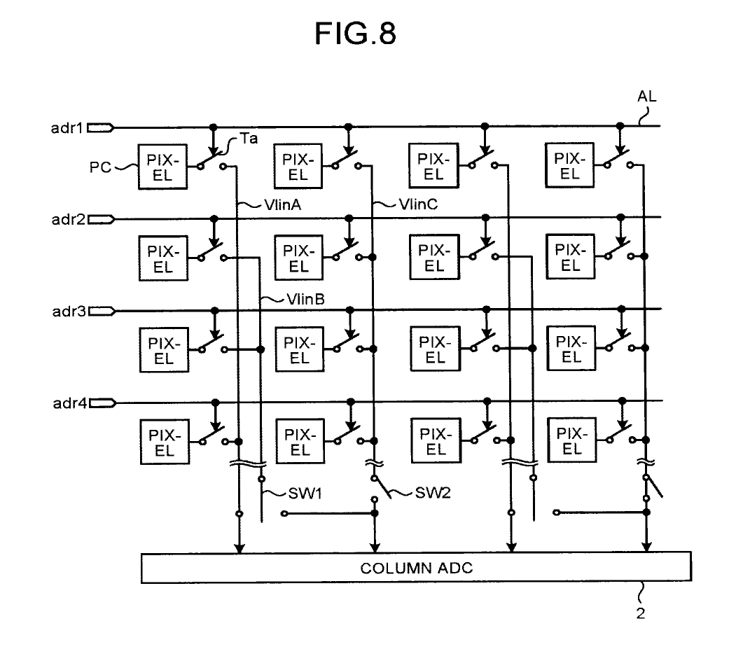

FIG. 8 is a block diagram illustrating an example of a configuration of a vertical signal line of a solid state imaging device according to a third embodiment. Note that in FIG. 8, there is illustrated an example of pixels PC arranged in a matrix state of 4×4 in a row direction and in a column direction.

In FIG. 8, one address line AL is provided per row in a pixel array unit 1. Then, the address line AL is connected to the pixel PC through a row selection transistor Ta. Here, the address line AL can transmit row selection signals adr1 to adr4 per row. Furthermore, vertical signal lines VlinA and VlinB, which transmit a pixel signal read from the pixel PC in the column direction, are provided in an odd-numbered column, and a vertical signal line VlinC, which transmits the pixel signal read from the pixel PC in the column direction, is provided in an even-numbered column. Here, each of the vertical signal lines VlinA and VlinB is alternately connected to every other pixel PC in the column direction.

Furthermore, switches SW1 and SW2 are provided in this solid state imaging device. The switch SW1 is capable of switching between a state in which the vertical signal line VlinB is connected to a column ADC circuit 2 through the vertical signal line VlinA, and a state in which the vertical signal line VlinB is connected to the column ADC circuit 2 through the vertical signal line VlinC. The switch SW2 can switch between a connected state and a disconnection state between the vertical signal line VlinC and the column ADC circuit 2.

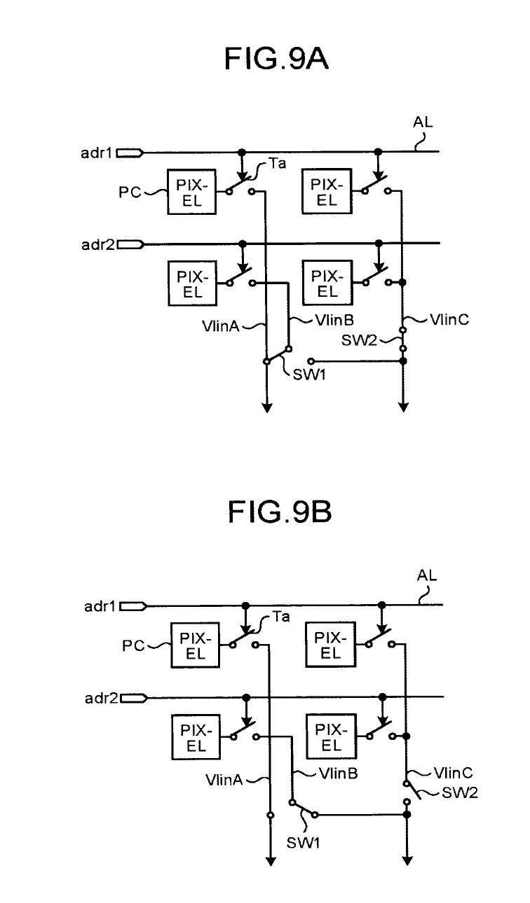

FIG. 9A is a block diagram illustrating a switching method of the switch in normal reading of the solid state imaging device in FIG. 8, and FIG. 9B is a block diagram illustrating a switching method of the switch in high speed reading of the solid state imaging device in FIG. 8.

In FIG. 9A, in the normal reading, the pixel signal is read from the pixel PC per line. Then, the pixel signal read from the pixel PC is transmitted to the column ADC circuit 2 per column.

That is, the switch SW1 is switched over to the vertical signal line VlinA side, and the vertical signal line VlinB is connected to the column ADC circuit 2 through the vertical signal line VlinA. Furthermore, the switch SW2 is turned on, and the vertical signal line VlinC is connected to the column ADC circuit 2.

Then, the row selection signal adr1 rises, and the row selection transistor Ta in a first row is turned on. Then, the pixel signal read from the pixel PC in the odd-numbered column is transmitted to the column ADC circuit 2 through the vertical signal line VlinA. Furthermore, the pixel signal read from the pixel PC in the even-numbered column is transmitted to the column ADC circuit 2 through the vertical signal line VlinC.

Next, the row selection signal adr2 rises, and the row selection transistor Ta in a second row is turned on. Then, the pixel signal read from the pixel PC in the odd-numbered column is transmitted to the column ADC circuit 2 through the vertical signal line VlinA. Furthermore, the pixel signal read from the pixel PC in the even-numbered column is transmitted to the column ADC circuit 2 through the vertical signal line VlinC.

In FIG. 9B, the pixel signal is read for two lines from the pixel PC in the high speed reading. Then, the pixel signal read from the pixel PC is transmitted to the column ADC circuit 2 for every other column.

That is, the switch SW1 is switched over to the vertical signal line VlinC side, and the vertical signal line VlinB is connected to the column ADC circuit 2 through the vertical signal line VlinC. Furthermore, the switch SW2 is turned off, and the vertical signal line VlinC is disconnected from the column ADC circuit 2.

Then, the row selection signals adr1 and adr2 simultaneously rise, and the row selection transistor Ta in first and second rows are turned on. Then, the pixel signal read from the pixel PC in an odd-numbered row of the odd-numbered column is transmitted to the column ADC circuit 2 through the vertical signal line VlinA. Furthermore, the pixel signal read from the pixel PC in an even-numbered row of the odd-numbered column is transmitted to the column ADC circuit 2 through the vertical signal line VlinB. At this time, the pixel PC in the even-numbered column is thinned.

Accordingly, read time can be reduced by half in the high speed reading compared to the normal reading. Furthermore, in a case where the high speed reading is realized, the column ADC circuit 2 may be provided for one line, and it is not necessary to provide the column ADC circuit 2 for two lines, whereby it is possible to suppress an increase of a circuit scale. Furthermore, it is possible to compensate for a decrease in resolution by interpolating a thinned pixel using pixels adjacent to the right and left.

Note that in a case where a Bayer array is applied to the configuration in FIG. 8, it is possible to configure such that four pixels PC constituting the Bayer array are simultaneously read. That is, in the configuration in FIG. 8, a set of the vertical signal lines VlinA and VlinB and the vertical signal line VlinC are alternately arranged in every other column; however, in the Bayer array, the set of the vertical signal lines VlinA and VlinB and the vertical signal line VlinC can be alternately arranged in every two columns.

(Fourth Embodiment)

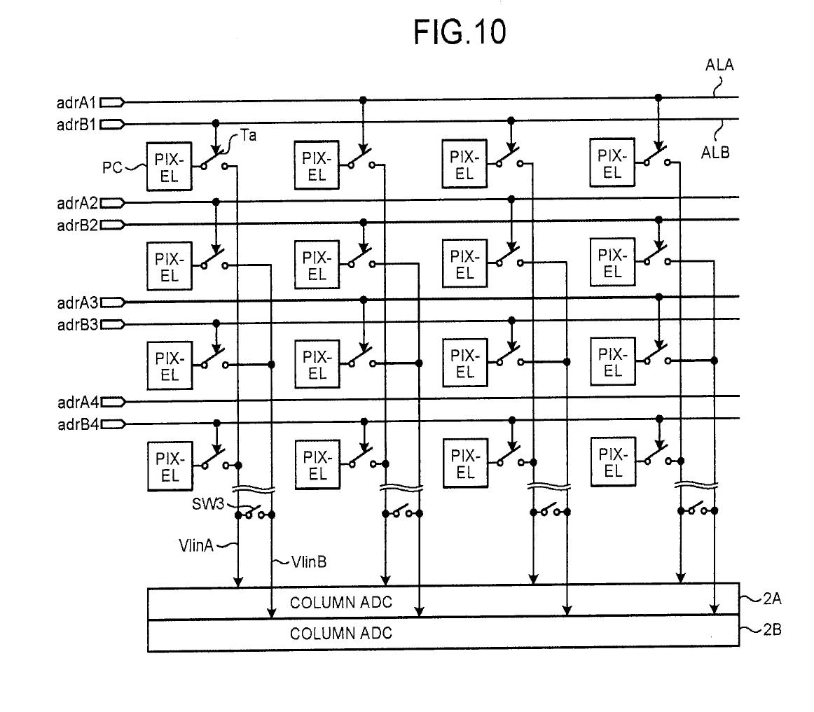

FIG. 10 is a block diagram illustrating an example of a configuration of an address line and a vertical signal line of a solid state imaging device according to a fourth embodiment. Note that in FIG. 10, there is illustrated an example of pixels PC arranged in a matrix state of 4×4 in a row direction and in a column direction.

In FIG. 10, a pixel array unit 1 is provided with two address lines ALA and ALB per row. Furthermore, the pixel array unit 1 is provided with two vertical signal lines VlinA and VlinB, which transmit a pixel signal read from the pixel PC in a column direction, per column. Here, the vertical signal lines VlinA and VlinB are alternately connected to every other pixel PC in the column direction.

Furthermore, the solid state imaging device is provided with column ADC circuits 2A and 2B for two lines. Here, the column ADC circuits 2A and 28 may have a gain different from each other. For example, the gain of the column ADC circuit 2B may be set to be four times of that of the column ADC circuit 2A. Furthermore, the solid state imaging device is provided with a switch SW3, which switches between a connection state and a disconnection state of the vertical signal lines VlinA and VlinB.

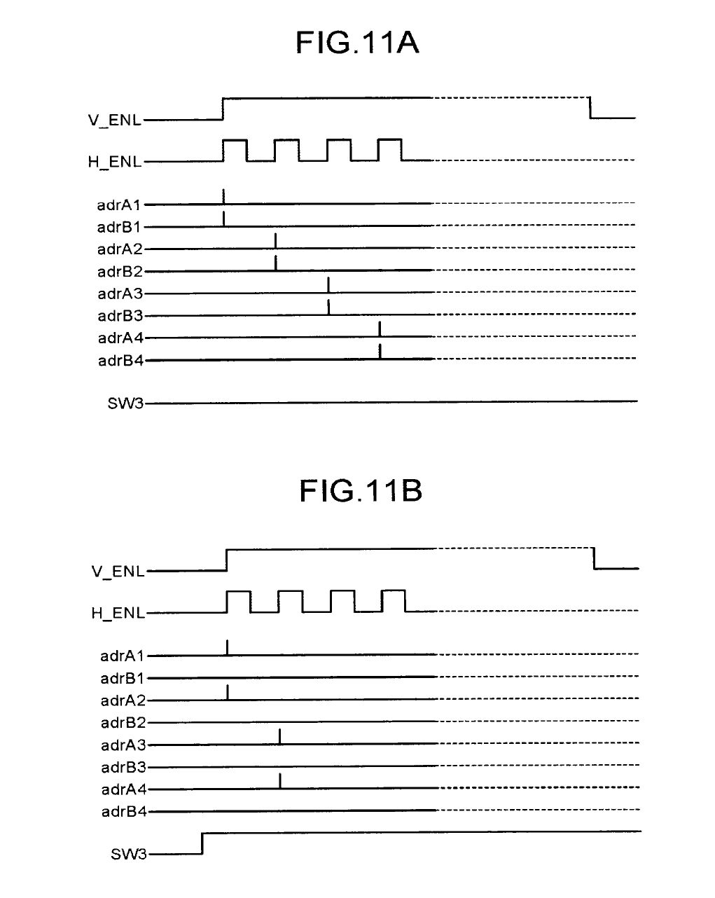

FIG. 11A is a timing chart illustrating an operation in normal reading of the solid state imaging device in FIG. 10, and FIG. 11B is a timing chart illustrating an operation in high speed reading of the solid state imaging device in FIG. 10.

In FIG. 11A, in the normal reading, two address lines ALA and ALB are simultaneously selected per row, and the pixel signal read from the same pixel PC is simultaneously amplified with a different gain.

That is, the vertical signal lines VlinA and VlinB are connected to each other by the switch SW3 being turned on. Then, after a vertical synchronization signal V_ENL rises, when row selection signals adrA1 and adrB1 simultaneously become a high level in synchronization with a horizontal synchronization signal H_ENL, a row selection transistor Ta of the pixel PC in a first row is turned on. Then, the pixel signal read form the pixel PC is simultaneously transmitted to the column ADC circuits 2A and 2B through the vertical signal lines VlinA and VlinB, and the pixel signal read from the same pixel PC is simultaneously amplified with different gains.

Hereinafter, in the same way, by row selection signals adrA2 to adrA4 and adrB2 to adrB4 becoming the high level in order in synchronization with the horizontal synchronization signal H_ENL, the signal is read in order from the pixel PC in the second to fourth rows.

In FIG. 11B, in the high speed reading, one address line ALA is simultaneously selected per two rows, and the pixel signal read from the pixel PC in a different row is simultaneously amplified with a different gain.

That is, by the switch SW3 being turned off, the vertical signal lines VlinA and VlinB are disconnected from each other. Then, after the vertical synchronization signal V_ENL rises, the row selection signals adrA1 and adrA2 simultaneously become the high level in synchronization with the horizontal synchronization signal H_ENL, and every other row selection transistor Ta of the pixels PC in first and second rows is alternately turned on in the row direction simultaneously. Then, the pixel signal read from the pixel PC is simultaneously transmitted to the column ADC circuits 2A and 2B through the vertical signal lines VlinA and VlinB, respectively. The pixel signals read from the pixels PC in the first and second rows are simultaneously amplified with different gains.

Hereinafter, in the same way, by the row selection signals adrA3 and adrA4 simultaneously becoming the high level in synchronization with the horizontal synchronization signal H_ENL, the signal is simultaneously read alternately from every other pixel PC in third and fourth rows in the row direction.

Here, in the normal reading, it is possible to simultaneously output the signal having a gain different from each other per line. Even in a case where a subject is moving at a high speed, it is possible to enlarge a dynamic range without accompanying a shift in imaging timing and to prevent an increase in read time. On the other hand, in the high speed reading as well, it becomes possible to enlarge the dynamic range without accompanying the shift in the imaging timing. Additionally, in the high speed reading, one period of time of the horizontal synchronization signal H_ENL is necessary for reading the signal for two rows, whereby it is possible to reduce the read time by half compared to the normal reading.

Note that in a case where a Bayer array is applied to the configuration in FIG. 10, it is possible to configure such that four pixels PC constituting the Bayer array are simultaneously read. That is, in the configuration in FIG. 10, the address lines ALA and ALB are alternately connected to every other pixel PC in the row direction through the row selection transistor Ta; however, in the Bayer array, the address lines ALA and ALB are alternately connect to every two pixels PC in the row direction through the row selection transistors Ta.

(Fifth Embodiment)

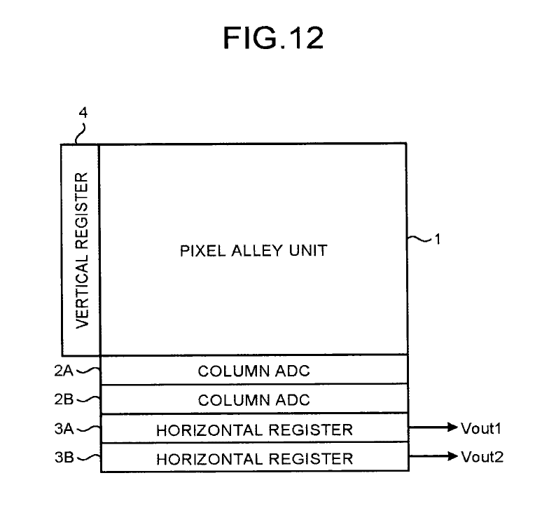

FIG. 12 is a block diagram illustrating a schematic configuration of a solid state imaging device according to a fifth embodiment.

In FIG. 12, the solid state imaging device is provided with a pixel array unit 1. In the pixel array unit 1, there is arranged pixels PC, which accumulate photoelectrically converted electrical charge, in a matrix state in a row direction and in a column direction. Furthermore, the solid state imaging device is provided with column ADC circuits 2A and 2B for two lines that detect, per column, a signal component of each of the pixels PC by a CDS, horizontal registers 3A and 3B that respectively forward the signal detected by the column ADC circuits 2A and 2B in a row direction, and a vertical register 4 that scans the pixel PC to be read in a column direction. Note that the column ADC circuits 2A and 2B may have gains different from each other.

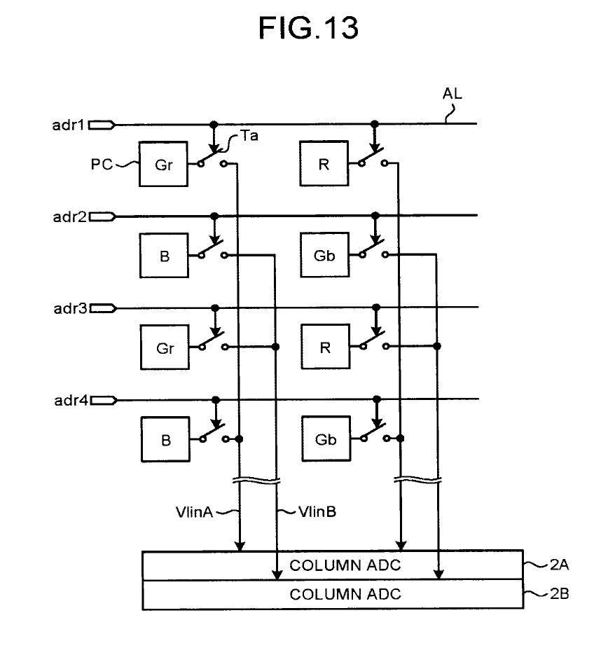

FIG. 13 is a block diagram illustrating an example of a configuration of an address line of the solid state imaging device in FIG. 12.

In FIG. 13, the pixel array unit 1 is provided with an address line AL per row. Furthermore, the pixel array unit 1 is provided with two vertical signal lines VlinA and VlinB, which transmit a pixel signal read from the pixel PC in the column direction, per column. Here, the vertical signal lines VlinA and VlinB are alternately connected to every other pixel PC in the column direction.

Then, when row selection signals adr1 and adr2 rise simultaneously, row selection transistors Ta of the pixel PC in first and second rows are turned on. Then, the pixel signal read from the pixel PC in the first and second rows is simultaneously transmitted to the column ADC circuits 2A and 23 through the vertical signal lines VlinA and VlinB, respectively, and the pixel signal read from the pixel PC in the first and second rows is simultaneously amplified with a different gain.

Accordingly, it is possible to simultaneously output the signal in a gain different from each other for each line. Even in a case where a subject is moving at a high speed, it is possible to enlarge a dynamic range without accompanying a shift in imaging timing and to prevent an increase in read time.

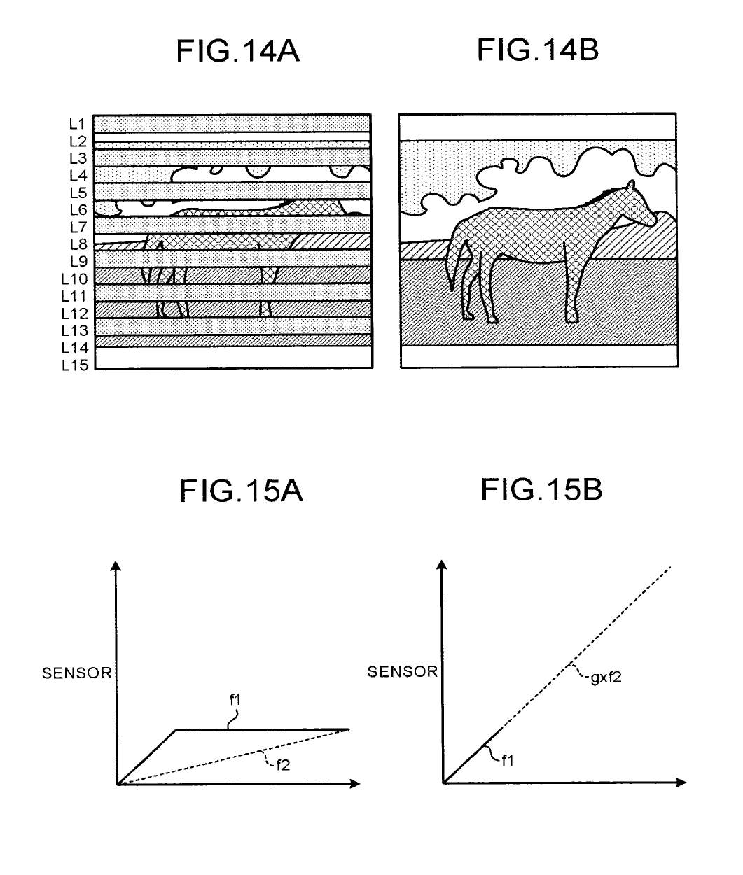

FIG. 14A is a view illustrating an output image in which the gain is made different between the lines of the solid state imaging device in FIG. 12, and FIG. 14B is a view illustrating a synthetic image in which an output image of FIG. 14A is synthesized.

In FIG. 14A, the gain is made different between the lines in a case where the dynamic range is enlarged. For example, the gain is set to one times for lines L1, L3, L5, L7, L9, L11, L13, and L15, and the gain is set to four times for lines L2, L4, L6, L8, L10, L12, and L14. Then, the line having a low gain is used for low sensitivity, and the line having a high gain is used for high sensitivity. In a case where the low sensitivity side is saturated, as illustrated in FIG. 14B, it is possible to enlarge the dynamic range by interpolating a saturated pixel with a high sensitivity pixel therearound.

FIG. 15A is a view illustrating sensor output in which the gain is made different between the lines of the solid state imaging device in FIG. 12, and FIG. 15B is a view illustrating a method of synthesizing the sensor output in FIG. 15A.

In FIG. 15A, by making the gain different between the lines, it is possible to obtain a pixel having a high sensitivity feature f1 and a pixel having a low sensitivity feature f2. Then, it is possible to enlarge the dynamic range by amplifying the pixel signal of the low sensitivity feature f2 by g times.

Note that in the above-described fifth embodiment, there has been described a method of providing two vertical signal lines per column of the pixel array unit 1, which are connected to every other pixel in a column direction, and of providing the column ADC circuit for two lines. Note that it is also possible to provide m vertical signal lines (m is an integer of two or more) per column of the pixel array unit, to connect it to every (m−1) pixel in the column direction, and to provide m column ADC circuits, each having a different gain.

(Sixth Embodiment)

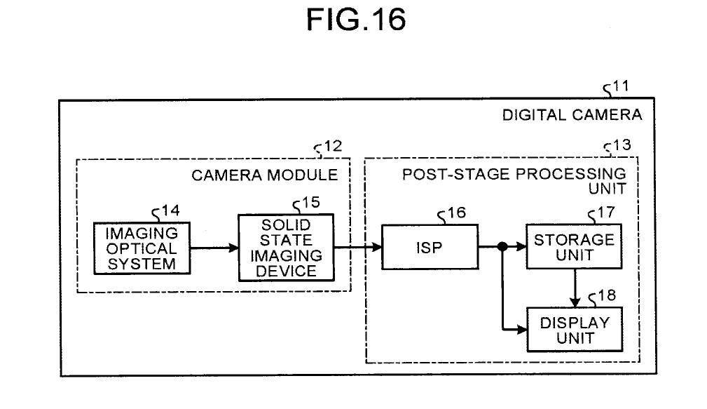

FIG. 16 is a block diagram illustrating a schematic configuration of a digital camera to which a solid state imaging device according to a sixth embodiment is applied.

In FIG. 16, a digital camera 11 has a camera module 12 and a post-stage processing unit 13. The camera module 12 has an imaging optical system 14 and a solid state imaging device 15. The post-stage processing unit 13 has an imaging signal processor (ISP) 16, a storage unit 17, and a display unit 18. Note that the solid state imaging device 15 may also use configurations in FIG. 2, 6, 8, 10 or 13. Furthermore, at least a part of a configuration of the ISP 16 may be formed into one chip together with the solid state imaging device 15.

The imaging optical system 14 takes in light from a subject, and forms a subject image. The solid state imaging device 15 images the subject image. The ISP 16 performs signal processing of an image signal obtained in imaging by the solid state imaging device 15. The storage unit 17 stores an image that has undergone the signal processing by the ISP 16. The storage unit 17 outputs the image signal to the display unit 18 in accordance with user operation and the like. The display unit 18 displays the image in accordance with the image signal input from the ISP 16 or the storage unit 17. The display unit 18 is, for example, a liquid crystal display. Note that the camera module 12 may be applied, for example, to an electronic device such as a portable terminal with a camera in addition to the digital camera 11.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A solid state imaging device, comprising:
a pixel array unit in which a pixel, which accumulates photoelectrically converted electrical charge, is arranged in a matrix state;
m address lines (m is an integer of two or more) provided per row of the pixel array unit and configured to select the pixel in a row direction; and
a vertical signal line configured to transmit a pixel signal read from the pixel in a column direction.

2. The solid state imaging device according to claim 1, wherein
the address lines are connected to every (m−1)×n (n is a positive integer) pixel in the row direction,
in first reading operation, the m address lines are simultaneously selected per row, and
in second reading operation, one each of the address lines is simultaneously selected per m rows.

3. The solid state imaging device according to claim 1, wherein the address lines select the pixels different from each other in the row direction.

4. The solid state imaging device according to claim 3, wherein
the address lines are provided with a first address line and a second address line per column, and the first address line of an odd-numbered row selects an odd-numbered column, the second address line of the odd-numbered row selects an even-numbered column, the first address line of an even-numbered row selects the even-numbered column, and the second address line of the even-numbered row selects the odd-numbered column.

5. The solid state imaging device according to claim 4, wherein
in normal reading, the first address line and the second address line of a first row are simultaneously selected, and in high speed reading, the second address line of the first row and the second address line of a second row are simultaneously selected.

6. The solid state imaging device according to claim 5, wherein in the high speed reading, the pixel is thinned so as to correspond to a checkered pattern.

7. The solid state imaging device according to claim 3, wherein
the pixel constitutes a Bayer array, the address lines are provided with a first address line and a second address line per column, the first address line of an odd-numbered row selects first and second columns, the second address line of the odd-numbered row selects third and fourth columns, the first address line of an even-numbered row selects the third and fourth columns, and the second address line of the even-numbered row selects the first and second columns.

8. The solid state imaging device according to claim 3, wherein the vertical signal line is provided in plurality per column of the pixel array unit and transmits a pixel signal read from the pixels different from each other in the column direction.

9. The solid state imaging device according to claim 8, further comprising a plurality of column ADC circuits provided per vertical signal line of each column and detect, per column, the pixel signal transmitted through the vertical signal line.

10. The solid state imaging device according to claim 9, wherein the address lines are provided with a first address line and a second address line per column, the first address line of an odd-numbered row selects an odd-numbered column, the second address line of the odd-numbered row selects an even-numbered column, the first address line of an even-numbered row selects the even-numbered column, and the second address line of the even-numbered row selects the odd-numbered column.

11. The solid state imaging device according to claim 10, wherein the vertical signal line is provided with a first vertical signal line and a second vertical signal line per row, the first address line of the odd-numbered row is connected to the first vertical signal line of the odd-numbered column, the second address line of the odd-numbered row is connected to the first vertical signal line of the even-numbered column, the first address line of the even-numbered row is connected to the second vertical signal line of the even-numbered column, and the second address line of the even-numbered row is connected to the second vertical signal line of the odd-numbered column.

12. The solid state imaging device according to claim 11, wherein in normal reading, the first address line and the second address line of a first row are selected simultaneously, and in high speed reading, the first address line of the first row and the first address line of a second row are simultaneously selected.

13. The solid state imaging device according to claim 9, further comprising a switch configured to switch between a connection state and a disconnection state between the plurality of vertical signal lines.

14. The solid state imaging device according to claim 13, wherein the plurality of column ADC circuits has a gain different from each other.

15. The solid state imaging device according to claim 14, wherein by the switch being turned on, a pixel signal from one pixel is simultaneously input to the plurality of column ADC circuits.

16. A solid state imaging device, comprising:
a pixel array unit in which a pixel, which accumulates photoelectrically converted electrical charge, is arranged in a matrix state;
an address line configured to select the pixel in a row direction;
a first vertical signal line provided in a first column of the pixel array unit and configured to transmit a pixel signal read from an odd-numbered pixel in a column direction;
a second vertical signal line provided in the first column and configured to transmit the pixel signal read from an even-numbered pixel in the column direction;
a third vertical signal line provided in a second column of the pixel array unit and configured to transmit the pixel signal read from the pixel in the column direction; and
a column ADC circuit configured to detect the pixel signal per column.

17. The solid state imaging device according to claim 16, further comprising:
a first switch configured to switch between a state of connecting the second vertical signal line to the column ADC circuit through the first vertical signal line, and a state of connecting the second vertical signal line to the column ADC circuit through the third vertical signal line; and
a second switch configured to switch between a connection state and a disconnection state between the third vertical signal line and the column ADC circuit.

18. A solid state imaging device, comprising:
a pixel array unit in which a pixel, which accumulates photoelectrically converted electrical charge, is arranged in a matrix state;
m vertical signal lines (m is an integer of two or more) provided per column of the pixel array unit and connected to every (m−1) pixel in a column direction; and
m column ADC circuits configured to detect, per column, a pixel signal having a gain different from each other.

19. The solid state imaging device according to claim 18, wherein each of the m vertical signal lines is connected to the column ADC circuit having the gain different from each other.

20. The solid state imaging device according to claim 19, further comprising m horizontal registers corresponding to the m column ADC circuits, respectively.
